(19) United States
(12) Patent Application Publication
(10) Pub. No.: US 2014/0133520 A1
(43) Pub. Date: May 15, 2014

(54) NETWORK MANAGEMENT SYSTEM FOR FREQUENCY HOPPED TACTICAL RADIOS

(71) Applicants: Shoab A. KHAN, Islamabad (PK); Sana HABIB, Islamabad (PK); Anam SHAFIQ, Islamabad (PK)

(72) Inventors: Shoab A. KHAN, Islamabad (PK); Sana HABIB, Islamabad (PK); Anam SHAFIQ, Islamabad (PK)

(21) Appl. No.: 13/676,705

(22) Filed: Nov. 14, 2012

(51) Int. Cl. H04B 1/713

(52) U.S. Cl. CPC H04B 1/713
USPC 375/133

(57) ABSTRACT

The present invention uses pseudorandom sequence to develop a strategy for the parallel communication of frequency hopped tactical radios. For this purpose, both time division multiplexing and frequency division multiplexing are used.

### FIELD OF INVENTION

The present invention relates to the technical field of communication systems and more particularly this invention relates to tactical radio communication that uses psedurandom sequence to generate non overlapping parallel frequency patterns that enable multiple radios to communicate in parallel while they hop their carrier frequencies.

### BACKGROUND OF INVENTION

In tactical radio communication, security is a key concern which is achieved using frequency hopping.

Prior art patents look to the synchronization, frequency hopping and solving the problem of interference between participating stations. U.S. Pat. Nos. 4,998,290 and 7,233,770 B2 are typical in this respect.

From applicants' view point, prior art work does present the idea of generating non-overlapping parallel frequency hopping patterns which allow multiple communications to take place simultaneously while communication security is provided using frequency hopping.

### SUMMARY OF INVENTION

The object of the present invention is to develop a strategy that generates non-overlapping parallel frequency hopping patterns which allows the tactical radios to communicate in parallel. For this purpose, both time division multiplexing and frequency division multiplexing are used. Any number of radios that are communicating with each other form a net. All the radios in a net use the same set of frequencies for communication and the number of radios in a net can differ. For example, there can be only two radios in a net, one transmitter and one receiver or five radios in a net, one transmitter and four receivers, all using same set of frequencies. The total time that is allowed for communication in one time frame is divided between the number of radios making a net (R), so that each radio gets its turn for transmitting data. If R number of radios are present in a net and T is the total time for communication, then time given to a single radio (S_{T}) in a net for the transmission of data is:

S_{T}=T/R

In accordance with the present invention, an example that considers a network consisting of thirty radios is taken. Thirty radios can cause a maximum of fifteen simultaneous communications (since two radios are necessary to carry out communication). The frequencies at which the radios communicate is decided by psedurandom (PN) sequence. The example presented here shows three different time frames, and the number of hopping frequencies (H) assigned to each net in a given time frame is 8.

Subsets of bits from psedurandom sequence are used to generate a frequency and then these frequencies are assigned to the set of radios in a pattern that guarantees that there is never a frequency conflict. The frequencies are assigned in this pattern: all radios of net 1 are assigned some f₁ frequency, all radios of net2 are using f₂ frequency for communication, all radios of net 3 are given f₃ frequency for communication. Then after first hop, first set of radios are communicating at f₂ frequency, second set of radios are using f₃ frequency, third set of radios are using f₄ frequency and so on. In this way, a unique frequency is used by each communicating set of radios and it becomes possible for multiple set of radios to communicate simultaneously.

The features and objectives of the present invention are further explained by the following detailed description of preferred embodiments and from the drawings.

### DESCRIPTION OF DRAWINGS

FIG. 1 demonstrates the complete communication process.

FIG. 2 is a graphical diagram of a radio network that is serviced by the present invention.

FIG. 3 shows a TVR (Time VS Radio) graph.

FIG. 4 shows FVR (Frequency VS Radio) graph.

FIG. 5 shows the inner structure of Master LFSR block.

FIG. 6 explains how frequencies are generated.

FIG. 7 shows the assignment of frequencies to communicating set of radios.

FIG. 8 is a flow chart showing the steps in the development of a New Frequency Array.

FIG. 9 shows the radio network for second and third time frames.

### DETAILED DESCRIPTION OF PREFERRED EMBODIMENTS

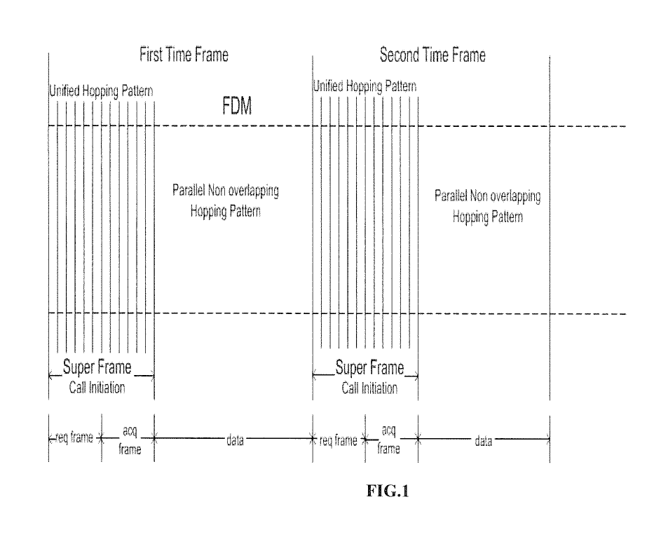

Referring to FIG. 1, a super frame is shown. This super frame consists of request and acknowledge frames and has 2C time slots, where C is the total number of radios in a network. First C time slots are given to the request frame and next C time slots are given to the acknowledge frame. During super frame, all radios hop on a unified hopping pattern and multiple access is granted using TDM (time division multiplexing). Each radio gets a time slot to perform call initiations, requesting the destination for communication. After C time slots, each radio gets a time slot to send an acknowledge signal to its requesting stations. After 2C slots, frequency division multiplexing (FDM) is taking place and all the pairs of communicating radios have parallel non overlapping frequency hopping patterns. It is not necessary for every radio to be involved in communication, a radio may or may not be involed in communication. The actual data is transmitted after the super frame.

All nets are given time T for communication. This time T is equally divided between the number of radios present in a net. For a net having 3 radios, T/3 time will be given to a single radio for transmission and for the rest of 2T/3 time units it will be receiving data from the other two radios. Moreover each radio has a radio-identifier (R_{I}) number associated with it. The radios of a net become transmitters in the ascending order of their R_{I}, that is the radio with the smallest R_{I} transmits first. In the next time frame, this whole process repeats again. A radio that enters in a net in rx mode sits at a fixed frequency and synchronizes with its tx radio.

Referring to FIG. 2, an example network consisting of thirty radios is shown. This network consits of eight communicating stations which are:
1. radio-1, radio-3 & radio-12.
2. radio-2, radio-4, radio-8, radio-10, radio-11 & radio-18.
3. radio-5, radio-15 & radio-26.
4. radio-6, radio-7, radio-13 & radio-30.
5. radio-9, radio-20, radio-25, radio-27 & radio-28.
6. radio-16 & radio-23.
7. radio-17 & radio-21.
8. radio-19 & radio-24.

radio-14, radio-22 & radio-29 are not taking part in communication in the first time frame. Let us consider the net consisting of radio-1, radio-3 and radio-12, where 1,3 and 12 are the R_{I}'s of the respective radios. During request frame, radio-1 sends a request signal in the first time slot of request frame to radio-3 and radio-12, radio-3 sends request signal in the third time slot of request frame to radio-1 and radio-12 and radio-12 sends a request signal (in the twelfth time slot of request frame) to radio-1 and radio-3. Then during acknowledge frame radio-1, radio-3 and radio-12 send acknowledge signals (in the first, third and twelfth time slot of acknowledge frame) to radio-3 & radio-12, radio-1 & radio-12 and radio-1 & radio-3 respectively, thus establishing a net. The radios become transmitter in the ascending order of their R_{I}'s, hence radio-1 becomes the transmitter first, then radio-3 and finally radio-12. Radio-1 first transmits for T/3 time units to radio-3 and radio-12, then radio-3 transmits for the next T/3 time units and finally radio-12 transmits data to radio-3 and radio-1.

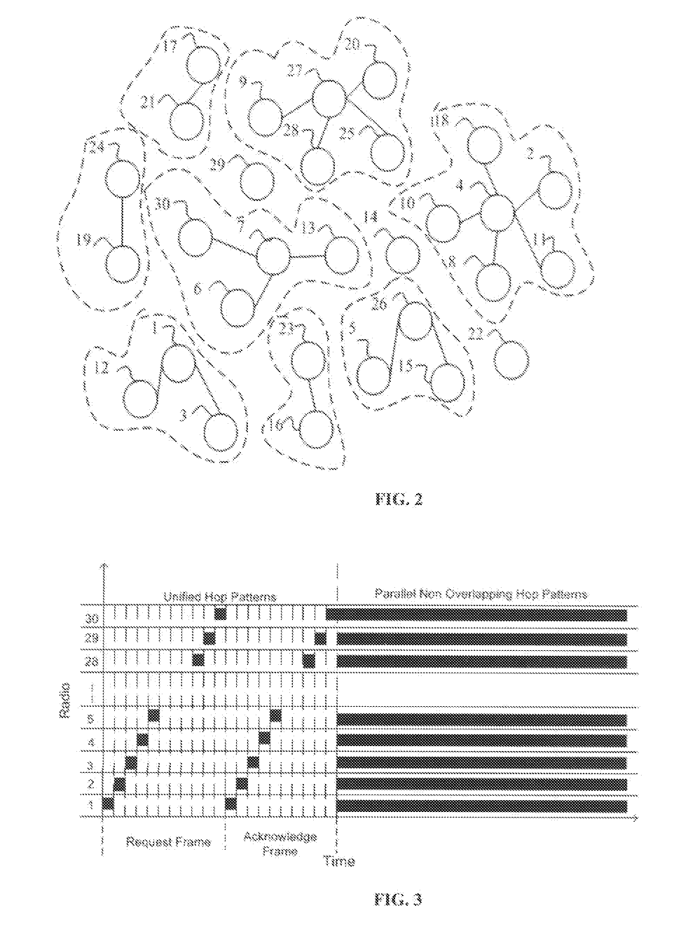

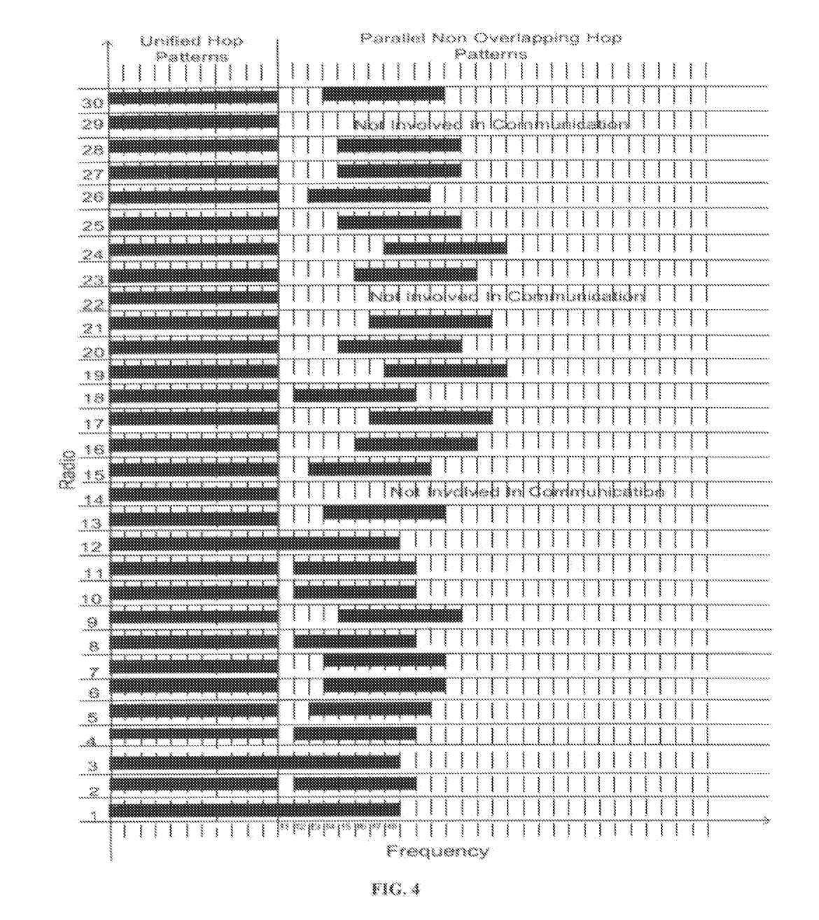

Referring to FIG. 3, TVR (time vs radio) graph is shown, where each dotted line represents a single time slot. During super frame, all radios are using unified hopping patterns but different time slots and after super frame, all radios are using same time slots but different frequency hopping patterns.

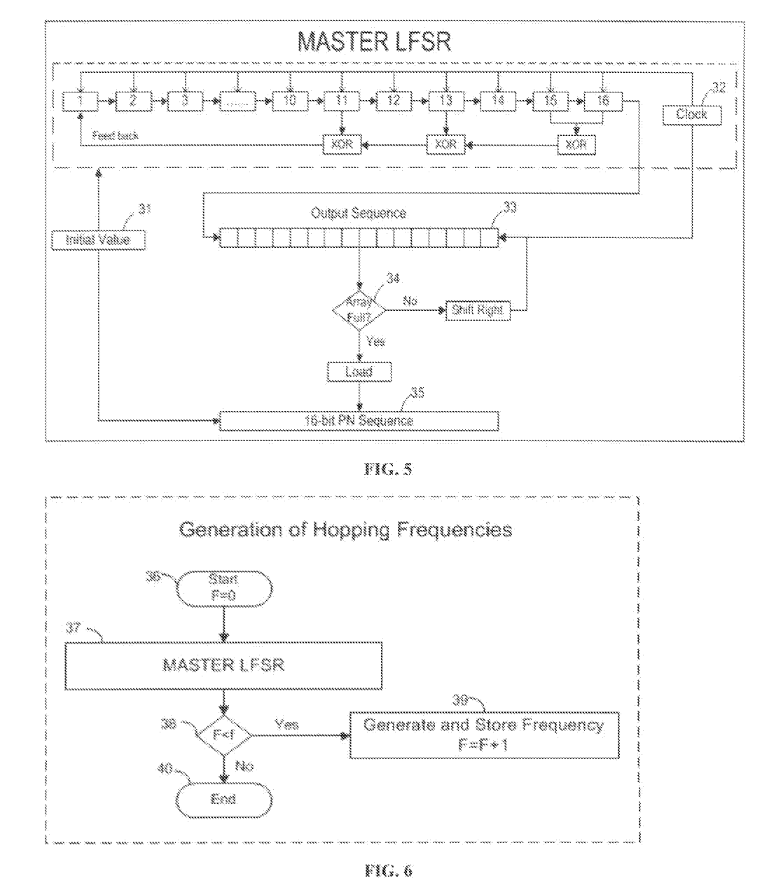

Referring to FIG. 4, FVR (frequency vs radio) graph is shown, where each dotted line represents a single frequency. Only the radios taking part in communication are assigned frequency hopping patterns. The FVR graph shows that radio-14, radio-22 and radio-29 are not assigned any hopping patterns, this is because they are not taking part in communication. All the radios of a net are assigned same set of frequencies so that synchronization is not a problem. FIG. 4 shows that radio-1, radio-3 and radio-12 have same set of frequencies and radio-2, radio-4, radio-8, radio-10, radio-11 & radio-18 share same frequency hopping pattern . Thus, all radios in a net have same set of frequencies. It can be seen that when radio-1, radio-3 and radio-12 are using frequency f₁, then radio-2, radio-4, radio-8, radio-10, radio-11 & radio-18 are communicating over frequency f₂, radio-5, radio-15 & radio-26 are using frequency f₃, thus simultaneous communication is taking place. After first hop, radio-1, radio-3 and radio-12 are using frequency f₂, radio-2, radio-4, radio-8, radio-10, radio-11 & radio-18 are using frequency f₃ and radio-5, radio-15 & radio-26 are communicating over frequency f₄. Hence there is always a unique frequency for each set of radios.

Referring to FIG. 5, the block of Master LFSR having 16 LFSRs is shown, which are used to generate a value. LFSR is a linear feed back shift register which gets its value updated after every clock cycle. Step-31 INITIAL VALUE loads an initial value in the LFSRs. Step 33-OUTPUT SEQUENCE is a 16-bit array and it stores the value produced by the 16th LFSR. Step-34-ARRAY FULL checks whether the array has all 16 values loaded in it or not. If array is not full, then each incoming entry shifts right to create space for the new incoming bit. After every 16 clock cycles, this array becomes full and the 16-bit value is loaded in step 35-16 BIT PN SEQUENCE. Clock indicated by step-32 is used to update a value in LFSR and depending on whether the condition indicated by step 34-ARRAY FULL (Step-33-OUTPUT SEQUENCE contains a 16-bit number or not) is true or false, respective actions are taken and values are updated. Therefore, the value in 16-BIT PN SEQUENCE is updated after every 16 clock cycles.

A network having C number of radios can carry out a maximum of C/2 communications as two radios are necessary for the transfer of information. Keeping that in mind, the example case consisting of thirty radios can carry out a maximum of fifteen communications. This means that in order to allow all the radios to communicate simultaneously while avoiding frequency conflict, maximum fifteen unique frequencies are needed. Although the example under consideration needs eight unique frequencies because there are eight nets, but it is possible that in the next time frame fifteen nets are formed so, in order to be sure that there is never a frequency collision always C/2 unique frequencies are generated.

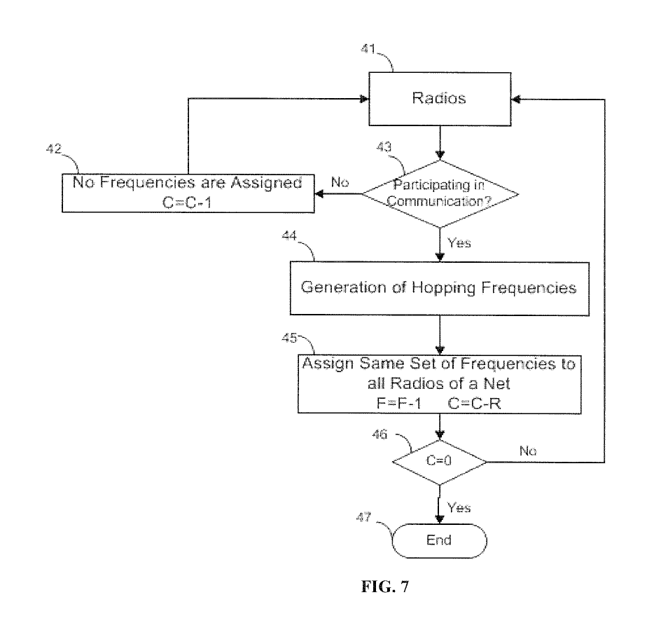

Referring to FIG. 6, F shows the total number of frequencies which are generated and f represents the maximum number of frequencies that can be generated with out repetition (since period of 16-bit LFSR is 65536 and 16-bits are used to generate a single frequency so, f=(65536/16)=4096). Once f number of frequencies have been generated, then the pattern in which f frequencies are produced will repeat. Every time a 16-bit number is obtained from Master LFSR block (shown by FIG. 5) indicated by Step-37 in FIG. 6, Step-38 F<f checks whether maximum number of frequencies have been produced or not. If F=f, then the process of generating frequencies ends, but if F<f, then a frequency is generated by taking the mod of 16-bit number with M, where M is the total number predefined frequencies that will be used for communication. In this way an index number Q, ranging from 0 to M is generated. After that Q is used to locate a frequency from the frequency table as shown in TABLE 1.

TABLE 1

| Frequency Index (Q) | Frequency (MHz) |
|---|---|
| 1 | f₁ |
| 2 | f₂ |
| 3 | f₃ |
| 4 | f₄ |
| 5 | f₅ |
| . . . | . . . |
| M | f_{M} |

Frequency column of TABLE 1 shows a set of predefined frequencies, which are used for communication. The selection of a particular frequency is made by frequency index Q. Once 4096 frequecies have been produced, then the process of generating frequencies ends.

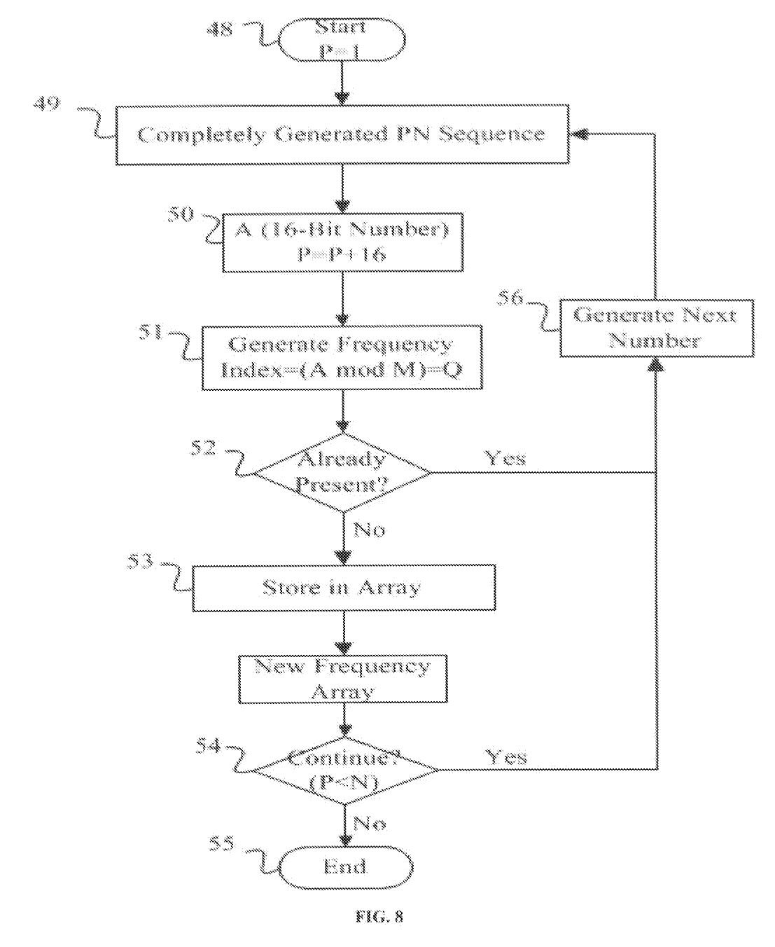

Referring to FIG. 7, all radios of the network shown by step-41 are checked by step-43 PARTICIPATING IN COMMUNICATION, for their participation in communication. If they are not participating, then no frequencies are assigned to that radio and C is decremented by 1 (C=30 for the example case). If the radios are participating in communication then the frequencies generated by GENERATION OF HOPPING FREQUENCIES block (shown in FIG. 6) indicated by Step-44 in FIG. 7 are assigned to all the radios of the same net. In step-45 F (maximum total number of frequencies generated) is decremented by 1 although, in this particular example communicating radios are using eight unique frequencies to communicate with each other but effectively there is just one frequency that won't be used again while assigning frequencies to the next set of radios. This is made clear by TABLE 2. Step-45 C is decremented by R, where R is the total number of radios present in a net. Step-46 C=0, checks whether all the radios have been asked about taking part in communication or not. If they have been, then the process ends indicated by step-47 otherwise it keeps on going to the next radio.

The frequencies are assigned to the communicating set of radios in the order shown by TABLE 2:

TABLE 2

| Nets | Frequency 1 | Frequency 2 | . . . | Frequency 8 |
|---|---|---|---|---|
| 1, 3, 12 | f₁ | f₂ | | f₈ |
| 2, 4, 8, 10, 11, 18 | f₂ | f₃ | . . . | f₉ |
| 5, 15, 26 | f₃ | f₄ | . . . | f₁₀ |
| 6, 7, 13, 30 | f₄ | f₅ | . . . | f₁₁ |
| 9, 20, 25, 27, 28 | f₅ | f₆ | . . . | f₁₂ |
| 16, 23 | f₆ | f₇ | . . . | f₁₃ |
| 17, 21 | f₇ | f₈ | . . . | f₁₄ |
| 19, 24 | f₈ | f₉ | . . . | f₁₅ |
| 14, 20, 29 | | Nil | | |

When radio-1, radio-3 & radio-12 are using frequency f₁ for communication, then radio-2, radio-4, radio-8, radio-10, radio-11 & radio-18 are using frequency f₂ and at the same time radio-5, radio-15 & radio-26 are using frequency f₃ and all are communicating simultaneously. After first hop, radio-1, radio-3 & radio-12 are using frequency f₂; radio-2, radio-4, radio-8, radio-10, radio-11 & radio-18 are using frequency f₃; radio-5, radio-15 & radio-26 are using frequency f₄ and so on. Hence there is always a unique frequency for each set of communicating radios.

Since index number Q is generated by taking mod so, possibility of repetition exists. This can pose serious problem as unique frequency for communication can not be guaranteed and frequency collision may occur. If some frequency f₃ is repeating then the problem created by repetition of frequency is shown by TABLE 3.

TABLE 3

| Nets | Frequency 1 | Frequency 2 |
|---|---|---|
| 1, 3, 12 | f₁ | f₂ |
| 2, 4, 8, 10, 11, 18 | f₂ | f₃ |
| 5, 15, 26 | f₃ | f₃ |
| 6, 7, 13, 30 | f₃ | f₄ |
| 9, 20, 25, 27, 28 | f₄ | f₅ |
| 16, 23 | f₅ | f₆ |
| 17, 21 | f₆ | f₇ |
| 19, 24 | f₇ | f₈ |
| 14, 20, 29 | Nil | Nil |

The problem of frequency collision is shown by second and third rows of column3, where net 1 and net 2 both happen to be using same frequency for communication due to which data received will be erreneous. In order to make sure that there is always a unique frequency for each communicating set of radios, a New Frequency Array is developed that guarantees that no consecutive fifteen frequencies are repeating (for the example, thirty radios are used so, maximum fifteen communications can take place and hence fifteen unique frequencies are needed).

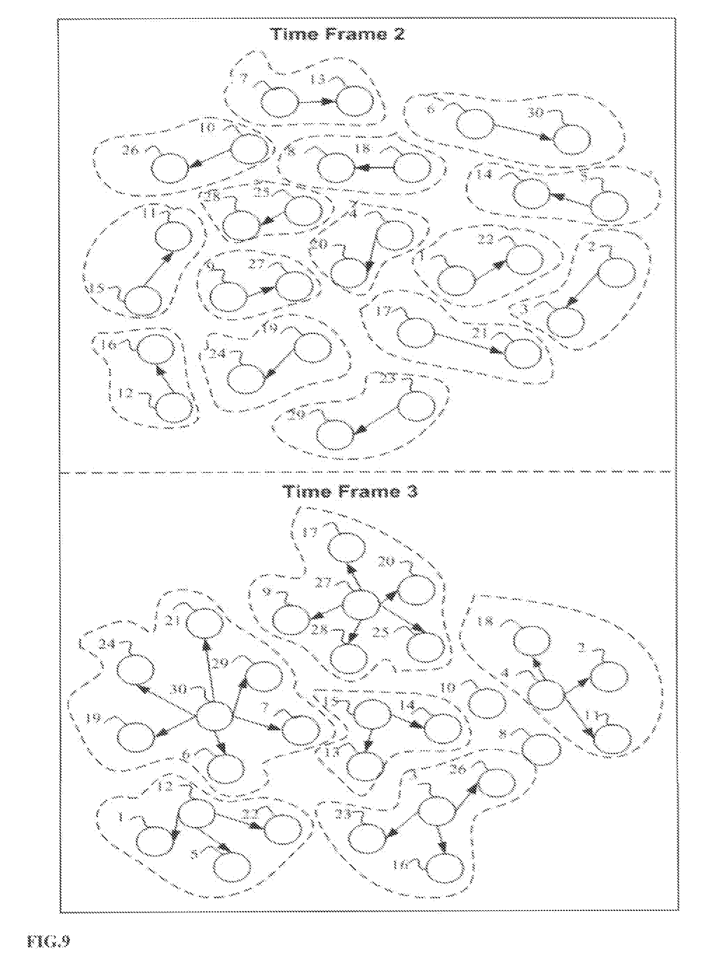

Referring to FIG. 8, N is the period of pseudorandom sequence which is 65535 (2^{m}−1, with m=16), starting with step 48-P=1, this process starts. Step 49-COMPLETELY GENERATED PN SEQUENCE is a completely generated PN sequence of length N. Step 50, takes a sixteen bit number A from step-49 and P is incremented by 16. Step 51-GENERATE FREQUENCY INDEX, generates a frequency index by taking mod of the 16-bit number A with M to generate a frequency index Q. Step 52-ALREADY PRESENT? checks whether the generated frequency index is already present in the frequency array, if it is not present then it goes to step 53-STORE IN ARRAY and frequency index is stored in New Frequency array, otherwise it goes to step 56-GENERATE NEXT NUMBER, which dicards the 16 PN sequence bits and generated frequency index and orders step-49 to give next sixteen bits which generates next frequency index. Step 54-CONTINUE? P<N, checks whether P is less than N, if it is then it goes to step 56, otherwise it goes to step 55-END and a complete New Frequency Array is obtained. The size of old Frequency Array indicated by step-39 was 4096 and the size of New Frequency Array (shown by FIG. 8) is 3630.

Hence a newly generated Frequency Array is obtained, which guarantees that consecutive fifteen frequencies are unique. So, the frequency array of FIG. 6 indicated by step-39 is replaced by New Frequency Array of FIG. 8.

The frequencies assigned by TABLE 2 are for the first time frame. In order to understand how frequencies are assigned in the next time frames refer to FIG. 9. FIG. 9 shows network diagrams for second and third time frames. In the second and third time frames, every radio is again checked for its participation in the communication process. After request and acknowledge frames, nets are formed and communication between radios of a net starts. The set of frequencies that have been assigned in the first time frame are not used again, instead the next set of frequencies are used.

TABLE 4 shows the assignment of frequencies in the second time frame.

TABLE 4

| Radio | Frequency 1 | Frequency 2 | . . . | Frequency 8 |
|---|---|---|---|---|
| 1, 22 | f₉ | f₁₀ | | f₁₆ |
| 2, 3 | f₁₀ | f₁₁ | . . . | f₁₇ |
| 4, 20 | f₁₁ | f₁₂ | | f₁₈ |
| 5, 14 | f₁₂ | f₁₃ | . . . | f₁₉ |
| 6, 20 | f₁₃ | f₁₄ | . . . | f₂₀ |
| 7, 13 | f₁₄ | f₁₅ | . . . | f₂₁ |
| 8, 18 | f₁₅ | f₁₆ | . . . | f₂₂ |
| 9, 27 | f₁₆ | f₁₇ | . . . | f₂₃ |
| 10, 26 | f₁₇ | f₁₈ | . . . | f₂₄ |
| 11, 15 | f₁₈ | f₁₉ | . . . | f₂₅ |
| 12, 16 | f₁₉ | f₂₀ | . . . | f₂₆ |
| 17, 21 | f₂₀ | f₂₁ | . . . | f₂₇ |
| 19, 24 | f₂₁ | f₂₂ | . . . | f₂₈ |
| 23, 29 | f₂₂ | f₂₃ | . . . | f₂₉ |
| 25, 28 | f₂₃ | f₂₄ | . . . | f₃₀ |

New nets are established between the radios in the next time frame. For instance, radio-1, radio-3 and radio-12 were communicating in the first time frame but in second time frame radio-1 and radio-22 are communicating, radio-3 and radio-2 form a net and radio-12 is communicating with radio-16. In the same way TABLE 5 shows the assignment of frequencies in the third time frame.

TABLE 5

| Nets | Frequency 1 | Frequency 2 | . . . | Frequency 8 |
|---|---|---|---|---|
| 1, 5, 12, 22 | f₂₄ | f₂₅ | | f₃₁ |
| 2, 4, 11, 18 | f₂₅ | f₂₆ | . . . | f₃₂ |
| 3, 16, 23, 26 | f₂₆ | f₂₇ | | f₃₃ |
| 6, 7, 19, 21, 24, 29, 30 | f₂₇ | f₂₈ | . . . | f₃₄ |
| 9, 17, 20, 25, 27, 28 | f₂₈ | f₂₉ | . . . | f₃₅ |
| 13, 14, 15 | f₂₉ | f₃₀ | . . . | f₃₆ |
| 8, 10 | | Nil | | |

In this way frequencies are assigned to the communicating pair of radios. We have a total of 3630 frequencies, after which they will start repeating.

The embodiment described relates to a system with thirty radios. However, this invention is not limited to thirty radios, it is possible to have more or less than thirty radios. The necessary condition for the working of this algorithm is, if a network consists of C radios, then a frequency array having C/2 unique frequencies should be produced, i-e any consecutive C/2 frequencies in the array should not be repeating.

1. (canceled)

2. The method of claim 7 further using a pseudorandom sequence for generating parallel non-overlapping hopping frequency patterns which are used by a communicating pair of radios.

3. The method according to claim 2 further applying a condition that C/2 frequencies generated by pseudorandom sequence are unique to avoid frequency collision.

4. The method of claim 3 further assigns frequencies to the network in such a pattern that the frequency used for communication by a network is a next communication frequency of another net.

5. The method of claim 4 further assigns same set of frequencies to all radios of a network synchronization.

6. The method of claim 5 wherein a plurality of radios communicate in parallel.

7. A method for simultaneous multi net communication system of narrow band tactical communication networks comprising radios, wherein:
(a) the radios are part of a net or multiple nets working in a physical premisis;
(b) the net generates an index for hopping by using Fast LFSR;
(c) taking the mode of a value to fit a unified frequency table across networks; and
(d) the Fast LFSR updates multiple times per second for fast hopping of all nets in the area.
